(19) United States
(12) Patent Application Publication
(10) Pub. No.: US 2006/0251037 A1
(43) Pub. Date: Nov. 9, 2006

(54) Apparatus and method for performance improvement of channel estimation in broadband wireless access communication system

(75) Inventors: Jin-Kyu Koo, Suwon-si (KR); Seok-Hyun Yoon, Suwon-si (KR); Su-Ryong Jeong, Suwon-si (KR); Dong-Seek Park, Yongin-si (KR); Young-Kwon Cho, Suwon-si (KR); Sung-Kwon Hong, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/374,731

(22) Filed: Mar. 14, 2006

(30) Foreign Application Priority Data
Mar. 14, 2005 (KR) 2005-21051

(51) Int. Cl. H04B 7/216

(52) U.S. Cl. 370/342

(57) ABSTRACT

Disclosed are a pilot tone generation apparatus and a pilot tone generation method for improving channel estimation performance in an OFDMA/CDM communication system. In a pilot tone generation method for channel estimation in a broadband wireless access communication system, if given data symbols and a pilot symbol are input, the input data symbols are code-division multiplexed. A pilot symbol value for generating a sub-carrier of a specific position into the pilot tone is produced and spread, correspondingly to a code-division multiplexed result value of the data symbols Also, a spreading value for the pilot symbol value and the resulting code-division multiplexed value of the data symbols are added up, and the pilot tone is generated at a given position on a frequency axis, which position is predetermined through a result of the adding up.

### PRIORITY

This application claims priority to applications entitled “Apparatus and Method for Performance Improvement of Channel Estimation in Broadband Wireless Access System” filed in the Korean Industrial Property Office on Mar. 14, 2005, and assigned Serial No. 2005-21051, the contents of which are incorporated herein by reference

### BACKGROUND OF THE INVENTION

1. Field of the Invention

The present invention relates generally to an Orthogonal Frequency Division Multiple Access/Code Division Multiplexing (OFDMA/CDM) communication system, and in more particular to a pilot tone generation apparatus and a pilot tone generation method for improving channel estimation performance in a OFDMA/CDM communication system.

2. Description of the Related Art

In an Orthogonal Frequency Division Multiplexing (OFDM) communication system, a transmitter such as a Base Station (BS) usually transmits Pilot Sub-Carrier (which is the same as Pilot Channel) signals to a receiver such as a Subscriber Station (SS). The BS transmits the pilot channel signals while simultaneously transmitting Data Sub-Carrier (which is the same as a Data Channel) signals. The transmission of the pilot channel signals seeks to achieve synchronization acquisition, channel estimation and BS discrimination.

The OFDM scheme, which has been used as a useful scheme for high-speed data transmission in a wired/wireless channel, is a data transmission scheme using a multi-carrier, and a kind of Multi-Carrier Modulation (MCM) scheme, in which serially input symbol strings are converted in parallel. The respective converted symbol strings are modulated with a plurality of mutually orthogonal sub-carriers, that is, a plurality of mutually orthogonal sub-channels, and they are then transmitted.

Although the OFDM scheme is similar to a Frequency Division Multiplexing (FDM) scheme, it is particularly characterized in that it can achieve optimal transmission efficiency at high-speed data transmission by transmitting data while maintaining orthogonality between the plurality of Sub-Carriers. It is also characterized in that since it has good frequency use efficiency and resistance to multi-path fading, it can efficiently achieve optimal high-speed data transmission e.

Furthermore, the OFDM scheme has advantages in that it can efficiently use frequencies due to the use of an overlapped frequency spectrum., It is resistant to including, but not limited to, frequency selective fading, and multi-path fading. Moreover, since the OFDM scheme can reduce an influence of Inter Symbol Interference (ISI) by using guard intervals, can simply design the structure of an equalizer, and is resistant impulsive noises, it shows a tendency to be actively used in communication system architectures.

The pilot channel signals operate as a kind of training sequence, which makes it possible to perform channel estimation between a transmitter and a receiver. An SS can discriminate a BS, to which it belongs, by using the Pilot Channel signals. The Pilot Channel signals are transmitted at a position prescribed in advance between the transmitter and the receiver that allows the Pilot Channel signals to operate as a kind of reference signal.

The Pilot Channel signals transmitted by the BS generate a pattern called a pilot pattern. In the existing OFDM system, the pilot patterns are distinguished by their slopes and starting points of transmission. Thus, the OFDM communication system must design the pilot patterns such that BSs constituting the OFDM communication system have different pilot patterns in order to distinguish the respective BSs on the basis of the pilot patterns.

In order to maximize the performance gain of the OFDM scheme as described above and use a plurality of Sub-Channel regions into which the total bandwidth is divided, communication systems which integrate characteristics of a Code Division Multiple Access (hereinafter referred to as “CDMA”) scheme with those of the OFDM scheme can be utilized. An example of these communication systems is a communication system employing an OFDMA/CDM scheme.

The OFDMA/CDM communication system uses a communication scheme which maximizes a performance gain by integrating the characteristics of the CDMA scheme with those of the OFDMA scheme, and is a communication system in which the CDM scheme is further applied in a frequency domain for purposes of reducing inter-cell interferences experienced in the OFDMA scheme. Below is a discussion of the characteristics of the OFDMA/CDM communication scheme.

In the OFDMA communication scheme, data symbols are mapped directly with a pilot symbol from Sub-Carrier to Sub-Carrier. The data symbols and the pilot symbol are spread with orthogonal codes, and are mapped with the sub-carrier via chip level summation.

Restoration of the data symbols and the pilot symbol require subjecting the same to a despreading procedure. The inter-cell interferences can be reduced by the despreading procedure. At this time, however, channel estimation performance in the OFDMA/CDM communication scheme is lowered as compared with a common OFDMA scheme using a pilot tone because the pilot symbol is also spread together with the data symbols which will be described below in more detail.

If CDM is applied to each of F Sub-Carriers, a spreading procedure, summating data symbols s₁, s₂, . . . , s_{F-1} and a pilot symbol p can be defined and expressed by Equation (1) below:

$$\underline{x} = \frac{1}{\sqrt{F}} {C}^{s} C \underline{s} \qquad ( 1 )$$

In Equation (1), x=[x₁ x₂ . . . x_{F}]^{T} denotes a value mapped with a Sub-Carrier as a result of the CDM of the data symbols and the pilot symbol, s=[s₁ s₂ . . . s_{F-1} p]^{T} denotes a vector consisting of the data symbols and the pilot symbol, C^{s}=diag (c¹^{s}, c₂^{s}, . . . , c_{F}^{s}) denotes a diagonal matrix whose diagonal elements are cell-specific long codes, and C=[c₁ c₂ . . . c_{F}] denotes a matrix whose column elements are orthogonal codes for performing the CDM, and F is the number of Sub-Carriers. Here, for the convenience of explanation, it will be assumed that c_{F} is an orthogonal code with which the pilot symbol is spread.

Next, the value mapped with the sub-carrier through the CDM, that is, x obtained from Equation (1), passes through a channel. Suppose that a signal having passed through the channel is y, then y can be expressed by the Equation (2) below:
y=Hx+n (2)

In Equation (2), y=[y₁ y₂ . . . y_{F}]^{T} denotes a reception vector received by a receiver after x passes through the channel, H=diag (h₁, h₂, . . . , h_{F}) denotes a diagonal matrix whose diagonal elements are channel values experienced by the respective Sub-Carriers, and n=[n₁ n₂ . . . n_{F}]^{T} denotes a noise, for example, an Additive White Gaussian Noise (AWGN).

If despreading is performed with the orthogonal code c_{F} in order to restore the pilot symbol from the reception vector y received by an SS, a result can be obtained as presented by Equation (3) below:

$$\frac{1}{\sqrt{F}} {\underline{c}}_{F}^{T} {C}^{s} \underline{y} = p \frac{1}{F} {\sum }_{j = 1}^{F} {H}_{j} + \frac{1}{F} {\sum }_{i = 1}^{F - 1} {s}_{i} {\sum }_{j = 1}^{F} {h}_{j} {c}_{Fj} {c}_{ij} + \frac{1}{\sqrt{F}} {\sum }_{j = 1}^{F} {c}_{Fj} {n}_{j} \qquad ( 3 )$$

In Equation (3), cᵢⱼ denotes a j-th component of cᵢ.

Looking into the right side of Equation (3), the reason why the channel estimation performance of the OFDMA/CDM scheme is inferior to that of the OFDMA scheme using the pilot tone can be determined as follows:

The first term in Equation (3), that is,

$$p \frac{1}{F} {\sum }_{j = 1}^{F} {h}_{j} ,$$

represents a multiplication value of the pilot symbol and a channel average. Here, a value obtained by dividing the multiplication value by the pilot symbol may be considered as a channel estimation value. That is, in the OFDMS scheme using the pilot tone, a channel value at a pilot tone position can be estimated by receiving the pilot tone. However, in the OFDMA/CDM scheme, the value obtained by restoring the pilot symbol has the channel average over the overall code-division multiplexed band, which obscures the channel estimation in the OFDMA/CDM scheme. Also, for channel interpolation, the obtained channel average is assumed as a channel value acquired from a Sub-Carrier of a specific position The channel estimation becomes further obscured as the position of the channel estimation value is arbitrarily assumed.

The second term in Equation (3), that is,

$$\frac{1}{F} {\sum }_{i = 1}^{F - 1} {s}_{i} {\sum }_{j = 1}^{F} {h}_{j} {c}_{Fj} {c}_{ij} ,$$

represents a value which acts as interferences from data symbols spread with other orthogonal codes because the orthogonality of the spreading code collapses due to the influence of the channel. As the pilot symbol must be despread before channel equalization, the OFDMA/CDM scheme is influenced by the interferences from the data symbols. Such interferences do not exist in the OFDMA scheme using the pilot tone. Thus, in view of a Signal to Interference and Noise Ratio (SINR), the performance of OFDMA/CDM scheme is inferior to that of the OFDMA scheme.

The third term in Equation (3), that is,

$$\frac{1}{\sqrt{F}} {\sum }_{j = 1}^{F} {c}_{Fj} {n}_{j} ,$$

represents a value to which channel noises are added. When the channel noises are AWGNs, a noise variance of the third term is the same as a variance of channel noises for one sub-carrier in the OFDMA scheme using the pilot tone.

In short, the OFDMA/CDM scheme has several problems in channel estimation performance as compared with the OFDMA scheme using the pilot tone. Such problems include:

A value obtained by restoring a pilot symbol is not a channel value of a Sub-Carrier located at a specific position but an average over the overall code-division multiplexed band, and the average obtained is assumed as a channel value acquired from a sub-carrier of a specific position. As a result performance deterioration of channel estimation occurs as compared with the OFDMA scheme. Also, since this causes the orthogonality of a spreading code to collapse there are interferences due to data symbols, which are spread, in the same band.

### SUMMARY OF THE INVENTION

Accordingly, the present invention has been made to solve at least the above-mentioned problems occurring in the prior art, and an object of the present invention is to provide a pilot tone generation apparatus and a pilot tone generation method for improving channel estimation performance in a communication system employing an OFDMA/CDM scheme.

In order to accomplish this object, in accordance with one aspect of the present invention, there is provided a pilot tone generation method for channel estimation in a broadband wireless access communication system, the method includes, if the given data symbols and a pilot symbol are inputted, code-division multiplexing the inputted data symbols; corresponding to a code-division multiplexed result value of the data symbols, producing and spreading a pilot symbol value for generating a Sub-Carrier of a specific position into the pilot tone; adding up a spreading value for the pilot symbol value and the code-division multiplexed result value of the data symbols; and generating the pilot tone at a given position on a frequency axis, for which the given position is predetermined through the adding up procedure.

In accordance with another aspect of the present invention, there is provided a channel estimation method in a broadband wireless access communication system, the method includes, if a given signal transmitted from a transmitter is received, generating the signal into a pilot tone at a given position in a frequency domain; verifying the pilot tone generated in the frequency domain to acquire channel estimation values; and acquiring channel estimation values for an overall band through interpolation for the acquired channel values.

In accordance with still another aspect of the present invention, there is provided a transmitter apparatus for generating and transmitting a pilot tone in a broadband wireless access communication system, the apparatus includes a code-division multiplexer for code-division multiplexing only given data symbols if the given data symbols and a pilot symbol are inputted; a pilot symbol spreader for, corresponding to a code-division multiplexed result value of the data symbols, producing and spreading a pilot symbol value for generating a Sub-Carrier of a specific position into the pilot tone; an adder for adding up a spreading value for the pilot symbol value and the code-division multiplexed result value of the data symbols; and a pilot tone generator for generating the pilot tone at a given position on a frequency axis, the given position being predetermined through the adding up procedure.

In accordance with another aspect of the present invention, there is provided a receiver apparatus for channel estimation corresponding to a pilot tone in a broadband wireless access communication system, the apparatus includes a fast Fourier transformer for transforming a given signal into a frequency-domain signal through baseband signal transform for the given signal and fast Fourier transform for a guard interval-removed signal if the given signal transmitted from a transmitter is received; and a channel estimator for verifying a pilot tone generated at a given position in the frequency domain to acquire channel estimation values corresponding to the pilot tone, and interpolating the channel estimation values to acquire channel estimation values for an overall band.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block diagram illustrating a procedure of performing channel estimation in a broadband wireless access communication system by applying a CDM scheme according to the prior art;

FIG. 2 is a schematic block diagram illustrating a procedure of performing channel estimation in a broadband wireless access communication system by applying a CDM scheme according to the present invention;

FIG. 3 is a schematic block diagram illustrating a transmitter structure of a broadband wireless access communication system in accordance with the present invention;

FIG. 4 is a schematic block diagram illustrating a receiver structure of a broadband wireless access communication system in accordance with of the present invention;

FIG. 5 is a flowchart illustrating a procedure of generating a pilot tone in a broadband wireless access communication system in accordance with of the present invention; and

FIG. 6 is a flowchart illustrating a procedure of channel estimation in a broadband wireless access communication system in accordance with of the present invention.

### DETAILED DESCRIPTION OF THE PREFERRED EMBODIMENT

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention provides an apparatus and a method for improving channel estimation performance in a communication system employing an OFDMA/CDM scheme by code-division multiplexing data symbols and also performing adaptive modulation for a pilot symbol, and generating a Sub-Carrier of a specific position into a pilot tone.

Prior to explaining the present invention, a CDM procedure of the prior art defined by Equation (1), will be discussed through redefining by Equation (4) below:

$$[ \begin{matrix}{x}_{1} \\ ⋮ \\ {x}_{F}\end{matrix} ] = \frac{1}{\sqrt{F}} {C}^{s} [ {\underline{c}}_{1} {\underline{c}}_{2} ⋯ {\underline{c}}_{F - 1} ] [ \begin{matrix}{s}_{1} \\ ⋮ \\ {s}_{F - 1}\end{matrix} ] + \frac{1}{\sqrt{F}} {C}^{s} {\underline{c}}_{F} p \qquad ( 4 )$$

As represented in Equation (4), a procedure of code-division multiplexing data symbols and a pilot symbol can be presented as a procedure of code-division multiplexing only the data symbols, spreading the pilot symbol, and adding the spread pilot symbol to the resulting code-division multiplexed data symbols. An object of the present invention is to make it possible to generate a specific element of x, that is equivalent to the resulting code-division multiplexed data symbols and the pilot symbol, into a desired value, that is equivalent to a pilot tone, by adaptively modulating a pilot symbol value.

For example, suppose that a q-th element of x is generated into a pilot tone p₁, and a pilot symbol value to be inputted is α, Equation (4) can also be expressed by Equation (5) below:

$$[ \begin{matrix}{x}_{1} \\ ⋮ \\ \begin{matrix}{p}_{1} \\ ⋮\end{matrix} \\ {x}_{F}\end{matrix} ] = {\underline{x}}^{D} + \frac{1}{\sqrt{F}} {C}^{s} {\underline{c}}_{F} a \qquad ( 5 )$$

In Equation (5), x^{D} denotes a result obtained by code-division multiplexing only data symbols which can be defined by Equation (6) below:

$${\underline{x}}^{D} = \frac{1}{\sqrt{F}} {C}^{s} [ {\underline{c}}_{1} {\underline{c}}_{2} ⋯ {\underline{c}}_{F - 1} ] [ \begin{matrix}{s}_{1} \\ ⋮ \\ {s}_{F - 1}\end{matrix} ] \qquad ( 6 )$$

When comparing only q-th elements on both sides in Equation (5), they can be defined by Equation (7) below:

$${p}_{1} = {x}_{q}^{D} + \frac{1}{\sqrt{F}} {c}_{q}^{s} {c}_{F q} a \qquad ( 7 )$$

In Equation (7), x_{q}^{D} denotes a q-th element of x^{D}, and a denotes an input pilot symbol value.

From Equation (7), a can be defined by Equation (8) below:

$$a = \frac{\sqrt{F}}{{c}_{q}^{s} {c}_{Fq}} ( {p}_{1} - {x}_{q}^{D} ) \qquad ( 8 )$$

In Equation (8), a denotes the pilot symbol value to be inputted, c_{q}^{s} denotes a q-th element of a diagonal matrix whose diagonal elements are cell-specific long codes, c_{Fq} denotes a q-th orthogonal code for spreading the pilot symbol, F denotes the number of sub-carriers to which CDM is to be applied, x_{q}^{D} denotes a q-th element of a result value obtained by code-division multiplexing only the data symbols, and p₁ denotes a pilot tone generated by the q-th element of the resulting code-division multiplexed value of only the data symbols.

Consequently, if only data symbols are code-division multiplexed, a pilot symbol is adaptively modulated as shown in Equation (8), and then the adaptively modulated pilot symbol value is added to the resulting code-division multiplexed value of the data symbols, that is, if a pilot symbol obtained from Equation (8) is substituted into Equation (5), it is possible to generate a Sub-Carrier value of a specific position on a frequency axis into a desired value. Since the Sub-Carrier is fixed to the desired value functions as a pilot tone, it can be used for channel estimation. Although the OFDMA/CDM scheme is employed in the present invention, the channel estimation can be performed using the pilot tone just as in the OFDMA scheme.

Hereinafter, the present invention will be described with reference to the accompanying drawings.

Prior to the discussion on a CDM scheme according to the present invention, a conventional CDM scheme will be first described for purposes of comparing with.

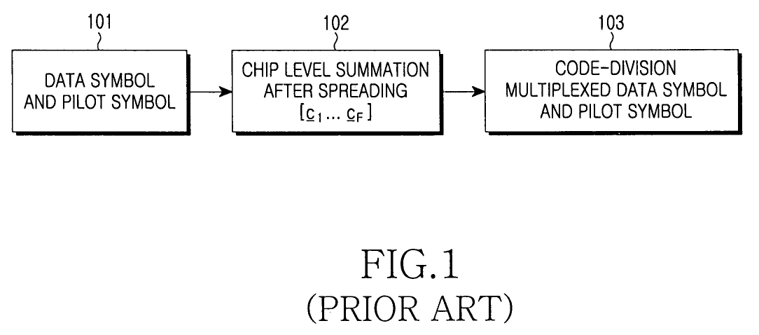

FIG. 1 is a schematic block diagram illustrating the existing CDM procedure of spreading data symbols and a pilot symbol, and performing chip level summation for the spread data symbols and the spread pilot symbol.

Referring to FIG. 1, the data symbols and the pilot symbol 101 are spread with orthogonal codes allocated to each of them, and thereafter, performing Chip Level Summation 102 on the spread data symbols and the spread pilot symbol. Blocks 101 and 102 indicate that the data symbols and the pilot symbol are code-division multiplexed with each other. Finally, the data symbols and the pilot symbol code-division multiplexed with each other are generated in block 103. Here, [c₁ c₂ . . . c_{F-1}] illustrated in FIG. 1 denotes that spreading is performed using orthogonal codes c₁, c₂, . . . , c_{F}, and then chip level summation and long code scrambling are performed.

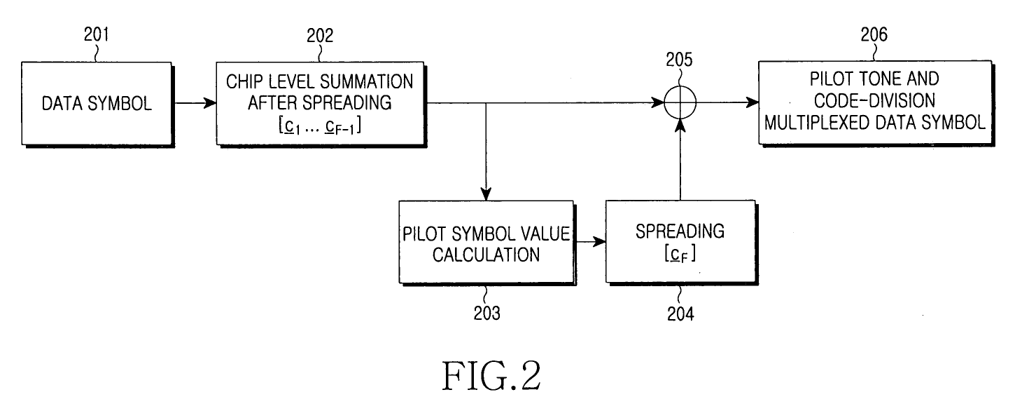

In FIG. 1, the conventional CDM scheme has been discussed for comparison with the present invention. A CDM scheme according to a the present invention is discussed below with reference to FIG. 2.

FIG. 2 is a schematic block diagram illustrating a CDM procedure of spreading data symbols and a pilot symbol, and performing chip level summation for the spread data symbols and the spread pilot symbol.

Referring to FIG. 2, in contrast with the conventional CDM scheme only data symbols in block 210 are spread with orthogonal codes allocated to each of them, and then chip level summation for the spread data symbols in block 202. Subsequently, from a result of the summation, a pilot symbol value is calculated through a pilot symbol calculation procedure, that is, Equation (8) in block 203. The so-calculated pilot symbol is spread with an orthogonal code allocated thereto in block 204, and then the spread pilot symbol is added to the output result of the summation in adder 205. Finally, the data symbols code-division multiplexed with the pilot symbol are produced through the above-mentioned steps in block 206. Here, [c₁ c₂ . . . c_{F-1}] illustrated in FIG. 2 denotes that spreading is performed using orthogonal codes c₁, c₂, . . . , c_{F-1}, and then chip level summation and long code scrambling are performed. Also, c_{F} denotes that spreading is performed using an orthogonal code c_{F}, and then long code scrambling is performed.

Hereinafter, a description will be given for the structures of a transmitter and a receiver of an OFDMA/CDM system, to which the present invention is applied.

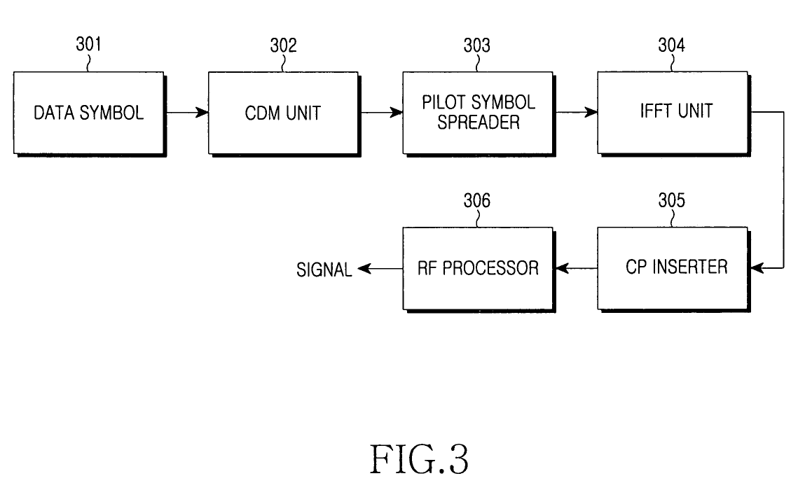

FIG. 3 is a schematic diagram illustrating the transmitter structure of the OFDMA/CDM system according to the present invention.

Referring to FIG. 3, the transmitter includes an input data symbol 301, a CDM unit 302, a pilot symbol spreader 303, an Inverse Fast Fourier Transform (IFFT) unit 304, a guard interval inserter 305 and a Radio Frequency (RF) processor 306.

First, if a data symbol 301 to be transmitted occurs, the data symbol 301 is input into the CDM unit 302. The CDM unit 302 then performs CDM for the input data symbol 301, and outputs the code-division multiplexed data symbol to the pilot symbol spreader 303. That is, the data symbol 301 is independently input into the CDM unit 302 and is code-division multiplexed through the CDM unit 302 without accompanying a pilot symbol.

The output signal from the CDM unit 302 is input into the CDM unit 302, the CDM unit 302 spreads an input pilot symbol to output the spread pilot symbol to the IFFT unit 304. The pilot symbol is calculated as in Equation (8), and then is spread through the pilot symbol spreader 303. Thereafter, the spread pilot symbol is added to the output result from the CDM unit 302. As a result of the operations of the pilot symbol spreader 303, a pilot tone is generated at a specific position on a frequency axis. The IFFT unit 304 inputs therein the output signal from the pilot symbol spreader 303 and performs N-point IFFT to then output an IFFT result to the guard interval inserter 305.

The guard interval inserter 305 inputs therein the output signal from the IFFT unit 304 and inserts a guard interval into the signal to then output the guard interval-inserted signal to the RF processor 306. Here, the guard interval is inserted in order to eliminate an interference between an OFDM symbol having been previously transmitted and an OFDM symbol to be currently transmitted when OFDM symbols are transmitted in an OFDMA communication system. The guard interval is inserted in either scheme of a Cyclic Prefix (CP) scheme, in which some last samples of OFDM symbols in a time domain are copied and inserted into an effective OFDM symbol, and a Cyclic Postfix (CP) scheme, in which some initial samples of OFDM symbols in a time domain are copied and inserted into an effective OFDM symbol. The RF processor 306 performs RF processing for the output signal from the guard interval inserter 305 such that the signal can be actually transmitted on air, and then transmits the processed signal on air through a transmit antenna (Tx Antenna).

In short, as illustrated in FIG. 3, a data symbol 301 is independently code-division multiplexed by means of the CDM unit 302 without accompanying a pilot symbol. It is calculated as shown in Equation (8) and spread, and then is added to the resulting value of CDM unit 302 by means of the pilot symbol spreader 303. Subsequently, as a result of the operations of the pilot symbol spreader 303, a pilot tone is generated at a specific position on a frequency axis. Next, the output of the pilot symbol spreader 303 is subjected to IFFT through the IFFT unit 304, which passes through the guard interval inserter 305 to add a guard interval (CP) thereto. It is then is converted into an RF domain and transmitted in the RF processor 306.

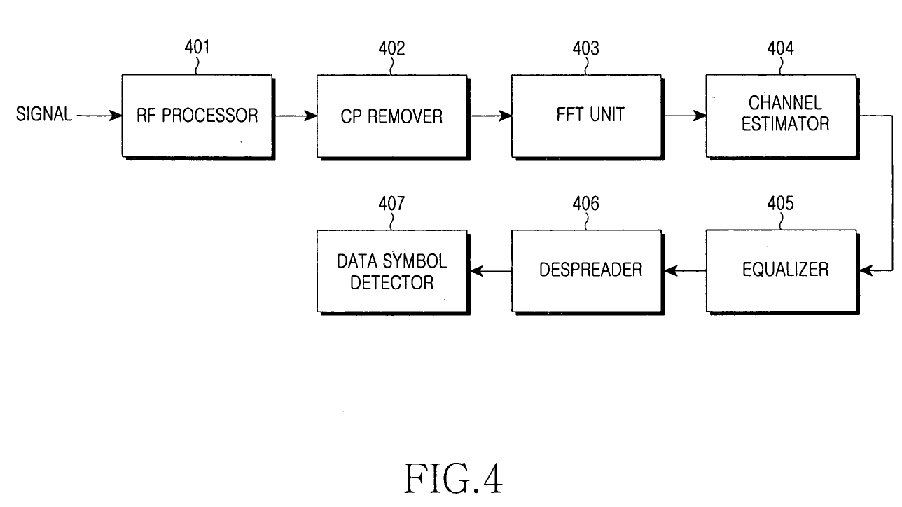

FIG. 3 describes the transmitter structure of the OFDMA/CDM communication system for performing functions of the present invention. Hereinafter, a receiver structure of the OFDMA/CDM communication system for performing functions of the present invention will be described below with reference to FIG. 4.

FIG. 4 is a schematic diagram illustrating the receiver structure of the OFDMA/CDM system according to the present invention.

Referring to FIG. 4, the receiver includes an RF processor 401, a guard interval remover 402, a Fast Fourier Transform (FFT) unit 403, a channel estimator 404, an equalizer 405, a despreader 406 and a data symbol detector 407.

First, a signal having been transmitted as described in FIG. 3 experiences a multi-path channel, and is received in a form with added noises through a receive antenna (Rx Antenna) of the receiver. The signal received through the Rx Antenna is input to the RF processor 401.

The RF processor 401 down-converts the received signal into a Intermediate Frequency (IF) band to then output the converted signal to the guard interval remover 402. The guard interval remover 402 inputs therein the output signal from the RF processor 401 to remove a guard interval, and then outputs the guard interval-removed signal to the FFT unit 403. The FFT unit 403 converts the output signal from the guard interval remover 402 into a frequency domain through N-point FFT, and then outputs the converted signal to the channel estimator 404.

The channel estimator 404 inputs therein the output signal from the FFT unit 403 to perform channel estimation, and then outputs the channel-estimated signal to the equalizer 405. In the channel estimator 404, channel estimation values are acquired by seeking pilot tone values generated at specific positions in the frequency domain. Also, channel estimation values for the overall band are acquired through interpolation between the acquired channel values.

The equalizer 405 inputs therein the output value from the channel estimator 404 to perform channel equalization, and then outputs channel-equalized signal to the despreader 406. Here, the equalizer 405 performs channel equalization based on the channel values for the overall band, which have been acquired by means of the channel estimator 404.

The despreader 406 inputs therein the output signal from the equalizer 405 to perform despreading in a corresponding manner to a spreading scheme applied to the transmitter, and then outputs the despread signal to the data symbol detector 407. Here, the despreader 406 does not perform despreading for a pilot symbol during the despreading procedure. The data symbol detector 407 inputs therein the output signal from the despreader 406 to restore a data symbol.

In short, as illustrated in FIG. 4, a signal inputted from the transmitter is converted into a baseband via the RF processor 401. In the guard interval remover 402, a guard interval is removed from the signal converted into the baseband. Subsequently, The guard interval-removed signal is converted into a frequency domain through the FFT unit 403. Then, in the channel estimator 404, channel estimation values are acquired by seeking pilot tone values generated at specific positions in the frequency domain, and channel estimation values for the overall band are acquired through interpolation between the acquired channel values. In the equalizer 405, channel equalization is performed based on the channel values, and then the output signal of the equalizer 405 passes through the despreader 406 to be despread and the despread signal is restored to a data symbol. In the receiver according to the present invention, despreading for a pilot symbol is not performed in the despreading procedure through the despreader 406.

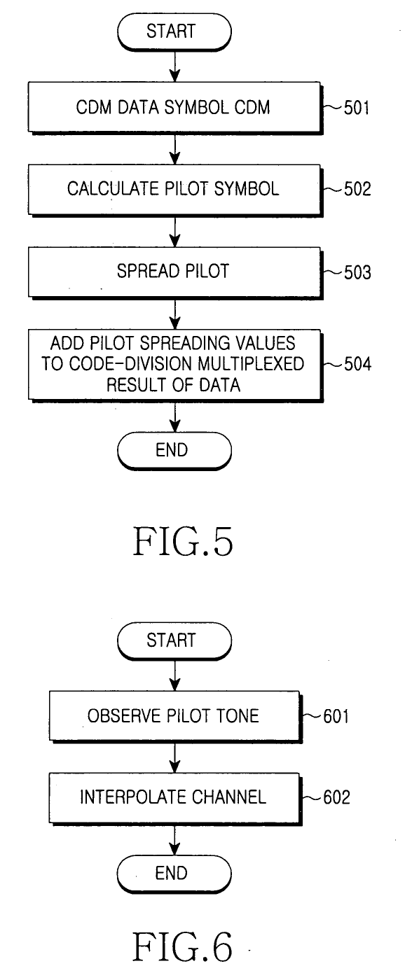

The transmitter structure and the receiver structure for performing functions in of the present invention have been described in FIGS. 3 and 4. Hereinafter, operation procedures of generating a pilot tone through the pilot symbol spreader 303 in FIG. 3 and performing channel estimation through the channel estimator 404 in FIG. 4 will be described with reference to FIGS. 5 and 6.

First, the pilot tone generation procedure will be discussed with reference to FIG. 5.

FIG. 5 is a flow diagram illustrating a pilot tone generation procedure in a transmitter of an OFDMA/CDM communication system according to the present invention.

Referring to FIG. 5, in step 501, CDM for an input data symbol is performed, and then the procedure proceeds to step 502. In step 502, a resulting code-division multiplexed of the data symbol is verified, a pilot symbol value to be input for generating a sub-carrier of a specific position into a pilot tone is calculated correspondingly to the resulting code-division multiplexed, and then the procedure proceeds to step 503. In step 503, only the pilot symbol calculated in step 502 is independently spread, and then the procedure proceeds to step 504. In step 504, the resulting code-division multiplexed of the data symbol and the spreading value of the pilot symbol are added up.

FIG. 5 describes the pilot tone generation procedure according to the present invention. Hereinafter, a channel estimation procedure will be described with reference to FIG. 6.

FIG. 6 is a flow diagram illustrating a channel estimation procedure in a receiver of an OFDMA/CDM communication system according to the present invention.

As already stated above, in the conventional OFDMA/CDM communication system, a pilot symbol is despread to acquire a channel estimation value for the sake of channel estimation. In contrast with this, as illustrated in FIG. 6, a despreading procedure for the pilot symbol is not performed in the present invention. In step 601, a channel estimation value is acquired by observing a specific tone value, i.e., a pilot tone value on a frequency axis without the despreading, and then the procedure proceeds to step 602. In step 602, the so-acquired channel estimation values are interpolated, through which channel estimation values for the overall band are acquired. By this, the channel estimation is completed.

According to the present inventive apparatus and the present inventive method for improving channel estimation performance in a broadband wireless access communication system, in particular, an OFDMA/CDM communication system, a sub-carrier value of a specific position on a frequency axis realizes the role of a pilot tone as a specific value, so that the channel estimation performance can be improved.

While the invention has been shown and described with reference to a certain preferred embodiment thereof, it will be understood by those skilled in the art that various changes in form and details may be made therein without departing from the spirit and scope of the invention as defined by the appended claims and equivalents thereof.

What is claimed is:

1. A pilot tone generation method for channel estimation in a broadband wireless access communication system, the method comprising:
if given data symbols and a pilot symbol are input, code-division multiplexing the input data symbols;
producing and spreading a pilot symbol value for generating a sub-carrier of a specific position into the pilot tone corresponding to a resulting code-division multiplexed value of the data symbols;
adding up a spreading value for the pilot symbol value and the resulting code-division multiplexed value of the data symbols; and
generating the pilot tone at a given position on a frequency axis for which the given position is predetermined through a result of the adding up.

2. The method as claimed in claim 1, wherein the step of code division multiplexing the data symbols further comprises performing spreading with orthogonal codes allocated to the data symbols, and performing chip level summation for the spread data symbols.

3. The method as claimed in claim 2, wherein in the chip level summation, long code scrambling is further performed.

4. The method as claimed in claim 1, wherein in the step of spreading the pilot symbol is performed with an orthogonal code allocated to the pilot symbol, and long code scrambling is performed.

5. The method as claimed in claim 1, wherein in the step of producing the pilot symbol value, the pilot tone is produced by means of the following
$$a = \frac{\sqrt{F}}{{c}_{q}^{s} {c}_{Fq}} ( {p}_{1} - {x}_{q}^{D} )$$
where, α denotes the pilot symbol value to be input, c_{q}^{s} denotes a q-th element of a diagonal matrix whose diagonal elements are cell-specific long codes, c_{Fq} denotes a q-th orthogonal code for spreading the pilot symbol, F denotes the number of sub-carriers to which code division multiplexing is to be applied, x_{q}^{D} denotes a q-th element of a result value obtained by code-division multiplexing only the data symbols, and p₁ denotes a pilot tone generated by the q-th element of the code-division multiplexed result value of only the data symbols.

6. A channel estimation method in a broadband wireless access communication system, the method comprising:
if a given signal transmitted from a transmitter is received, generating the signal into a pilot tone at a given position in a frequency domain;
verifying the pilot tone generated in the frequency domain to acquire channel estimation values; and
acquiring channel estimation values for an overall band through interpolation for the acquired channel values.

7. The method as claimed in claim 6, further comprising:
performing channel equalization through the channel estimation values for the overall band;
inputting a channel equalized-signal to perform despreading corresponding to a spreading scheme according to system settings; and
inputting the despread signal to restore the signal to received data symbols.

8. The method as claimed in claim 7, wherein the despreading is performed for only the data symbols.

9. A transmitter apparatus for generating and transmitting a pilot tone in a broadband wireless access communication system, the apparatus comprising:
a code-division multiplexer for code-division multiplexing only given data symbols if the given data symbols and a pilot symbol are input;
a pilot symbol spreader for producing and spreading a pilot symbol value for generating a sub-carrier of a specific position into the pilot tone, correspondingly to a resulting code-division multiplexed result value of the data symbols;
an adder for adding up a spreading value for the pilot symbol value and the resulting code-division multiplexed value of the data symbols; and
a pilot tone generator for generating the pilot tone at a given position on a frequency axis, the given position being predetermined through a result of the adding up.

10. The apparatus as claimed in claim 9, wherein the code-division multiplexer performs spreading with orthogonal codes allocated to the data symbols, and further performs chip level summation and long code scrambling for the spread data symbols.

11. The apparatus as claimed in claim 9, wherein the pilot symbol spreader performs the spreading with an orthogonal code allocated to the pilot symbol, and further performs long code scrambling.

12. The apparatus as claimed in claim 9, wherein the pilot symbol spreader comprises:
a pilot symbol calculator for calculating a pilot symbol to be input for generating the sub-carrier of the specific position into the pilot tone; and
a spreader for spreading the calculated pilot symbol.

13. The apparatus as claimed in claim 12, wherein the pilot symbol calculator produces the pilot symbol value to be input for pilot tone generation by
$$a = \frac{\sqrt{F}}{{c}_{q}^{s} {c}_{Fq}} ( {p}_{1} - {x}_{q}^{D} )$$
where, α denotes the pilot symbol value to be input, c_{q}^{s} denotes a q-th element of a diagonal matrix whose diagonal elements are cell-specific long codes, c_{Fq} denotes a q-th orthogonal code for spreading the pilot symbol, F denotes the number of sub-carriers to which code division multiplexing is to be applied, x_{q}^{D} denotes a q-th element of a result value obtained by code-division multiplexing only the data symbols, and p₁ denotes a pilot tone generated by the q-th element of the resulting code-division multiplexed value of only the data symbols.

14. A receiver apparatus for channel estimation corresponding to a pilot tone in a broadband wireless access communication system, the apparatus comprising:
a Fast Fourier transformer for transforming a given signal into a frequency-domain signal through baseband signal transform for the given signal and Fast Fourier transform for a guard interval-removed signal if the given signal transmitted from a transmitter is received; and
a channel estimator for verifying a pilot tone generated at a given position in the frequency domain to acquire channel estimation values corresponding to the pilot tone, and interpolating the channel estimation values to acquire channel estimation values for an overall band.

15. The apparatus as claimed in claim 14, further comprising:
an equalizer for performing channel equalization based on the channel estimation values for the overall band, which are acquired through the channel estimator;
a despreader for performing despreading only for channel equalized-data symbols; and
a data symbol detector for performing restoration for the data symbols despread through the despreader.

16. The apparatus as claimed in claim 15, wherein the despreader omits despreading for a pilot symbol.
